(19) United States
(12) Patent Application Publication
(10) Pub. No.: US 2017/0361511 A1
(43) Pub. Date: Dec. 21, 2017

(54) MOLD FOR MANUFACTURING PLASTIC PARTS

(71) Applicant: Jean Yves SOZET, Vion (FR)

(72) Inventor: Jean Yves SOZET, Vion (FR)

(73) Assignee: Compagnie Plastic Omnium, Lyon (FR)

(21) Appl. No.: 15/532,763

(22) PCT Filed: Dec. 1, 2015
(86) PCT No.: PCT/FR2015/053282

§ 371 Date: Jun. 2, 2017

(30) Foreign Application Priority Data
Dec. 5, 2014 (FR) 1461958

(51) Int. Cl. B29C 43/36; B29C 33/00; B29C 43/02; B29C 71/00; B29L 31/00

(52) U.S. Cl. CPC B29C 43/361; B29C 43/021; B29C 71/0009; B29C 33/0033; B29C 2043/3613; B29C 2071/0045; B29C 2793/0045; B29L 2031/737; B29C 2043/3626

(57) ABSTRACT

The invention relates to a mold for manufacturing a plastic part, including a first element and a second element forming, in the closed position of the mold, a cavity corresponding to the part to be manufactured, in which the second element includes at least one system for making molding openings in said part, said system including at least one member forming a cavity of an opening for the finished part, said member being movable relative to the second element in the closing direction of the mold, between a retracted position and an position extending into the cavity. The system includes at least one positioning means for positioning the member in the extended position relative to the first element, said system being sized such that, in the extended position of the member, the distance between a surface of the member bearing on the plastic material and the first element enables the formation of a thin layer of plastic material having a repeatable thickness.

### FIELD OF THE INVENTION

This invention relates to the technical field of manufacturing plastic parts by molding and in particular parts comprising openings.

### BACKGROUND OF THE INVENTION

It may concern in particular, but not exclusively, motor vehicle structural parts, such as technical front sides, wing supports and floors.

A characteristic of such parts is that they comprise through openings while having to retain good mechanical strength.

To produce a plastic part, it is known to use a molding method, such as compression and/or injection and/or extrusion molding.

Molding by hot compression under pressure in a mold is generally carried out by displacing a moving element of the mold moved (moved by a press) relative to a fixed element of the mold, these elements being typically made of steel.

Generally, a loading plane consisting of sheets of plastic material, typically an SMC (sheet molding compound) composite material, is placed in a compression mold.

The press is then actuated to close the mold. The mold is said to descend (close) to a closed position.

Actuation of the press then continues to transmit a molding pressure to the plastic material. The mold is said to be in packing phase. The plastic material can then flow and take the shape of the mold cavity.

Lastly, during a “curing” phase, the plastic material polymerizes to form a finished part.

To make an opening in the final part, one possibility would be to design the mold with an opening cavity, in other words a local and molding shape for each opening.

For example, the mold could include a pin, located on the periphery of the cavity and not opposite the loading plane, having the shape of the required opening, on a mold element which would come into contact with the other element when the mold closes.

However, when the plastic material flows, the reinforcing fibers are preferably oriented according to the flow directions, consequently they will go around the pin then come together forming a join line. Consequently, the random orientation of the fibers is no longer controlled. This results in a preferred orientation of the reinforcing fibers, which may lead to anisotropy of the part, which will therefore have different mechanical behavior depending on the directions of the forces imposed, possibly inducing robustness less than the requirement in some areas of the finished part. In addition, the join lines generally contain no reinforcing fibers.

Consequently, to obtain a plastic part comprising through openings, the plastic part must first be molded, then after removal from the mold, the openings must be produced using another piece of equipment, for example by machining or punching at the required positions to form through openings.

The equipment required must therefore include, in addition to molding equipment, a machining cell, or a punching system, integrated with the part manufacturing cycle. Such equipment is expensive, increases the cycle time and generates dust and scraps from the material removed.

To avoid this rework step, a mold which can be used to produce molding openings using movable pins is known. The pins are actuated by hydraulic cylinders. These pins are lowered into the mold cavity after the plastic material has flowed and before polymerization.

However, this type of in situ molding system suffers too much wear during use, since the pins knock against the opposite side of the mold and rub against the reinforcing fibers which are abrasive. Consequently, the pin and the mold are damaged.

To avoid damaging such pins, a mold is known comprising, in the cavity, opposite the movable pin, an interchangeable wearing part, sometimes called a fixed counter-pin, which can be taken out of the mold and replaced when it is too damaged.

Another technique to avoid damaging the pins (movable or fixed), consists in allowing, in the closed position of the mold, a minimum clearance between the pin and the opposite side of the mold. This minimum clearance is set to maintain a minimum distance between the two sections of the mold, taking into account the production dispersions on the thickness of the parts (e.g. 0.4 mm), in particular when the parts are very thin. Thus, the material is not completely pushed away and a layer of material of non-repeatable thickness from one part to another is left at the bottom of the opening. This residual layer is then removed in an additional production step. During molding, there is a dispersion in the thickness of the molded part, related to the variations in the industrial method due to different parameters such as the quantity of material implemented. Thus, considering the variations in the density of material, weight implemented and operation of the press, the residual layer may vary from 0.2 mm to 0.6 mm. A significant mechanical action must therefore be planned to remove this layer. For example, heavy equipment may be required for drilling, grinding or milling. Moreover, such equipment includes tools (drill, grinding wheel, milling cutter) which must be regularly replaced due to wear or damage. Lastly, such tools may be associated with problems of alignment relative to the opening to be molded.

### OBJECT AND SUMMARY OF THE INVENTION

The invention aims to remedy these disadvantages by providing a mold for manufacturing plastic parts such as motor vehicle structural parts, allowing the production of openings directly in the mold blocked by a very thin layer, of controlled thickness of approximately 0.1 mm. These openings are therefore intended to be through openings on the part mounted on the vehicle.

Thus, the invention relates to a mold for manufacturing plastic parts, comprising a first element and a second element forming, in the closed position of the mold, a cavity corresponding to the part to be produced. The second element comprises at least one system for producing molding openings in the part, said system comprises at least one positioning means for positioning the member in the extended position relative to the first element, said system being sized such that, in the extended position of the member, the distance between a surface of the member bearing on the plastic material and the first element enables the formation of a thin layer of plastic material having a repeatable thickness at the bottom of the opening.

The mold according to the invention can thus produce directly in the mold, openings blocked by a layer, so thin that it can be removed by simple mechanical actions.

Moreover, since the thickness of this layer is fixed irrespective of the actual thickness of the part, this simple mechanical action to remove the layers from each opening and each part can be guaranteed.

In addition, since the mechanical elements used in the mold do not touch each other when closing, the mold according to the invention is not damaged when producing the openings.

According to the invention, the positioning means can position the bearing surface of the member relative to the surface of the fixed element opposite the member when the member is in the extended position.

According to one embodiment, the positioning means comprises at least one movable plate provided with at least one mechanical stop, the movable plate being movable relative to the second element.

The mechanical stop can rest against the first element in the mold packing phase. Furthermore, this mechanical stop and the movable member are advantageously sized such that in the extended position of the movable member, the distance between the surface of the member bearing on the plastic material and the first element is not zero and less than 0.2 mm, preferably substantially equal to 0.1 mm.

The invention also relates to a method for manufacturing a plastic part having at least one opening, using the mold according to the invention, the method comprising at least the following steps:
positioning the plastic material in the mold cavity;
closing the mold;
packing the plastic material in the cavity, up to the nominal dimension of the part to be molded;
after flow of the plastic material and before polymerization of the plastic material, lowering the positioning means until the stop comes into contact with the mold element;
opening the mold and ejecting the part; and
removing the layer formed in the opening created by the pin.

According to the invention, the layer can be removed by a method of shot-peening, projection of CO2 crystals, washing with water jet or compressed air or a brush.

### BRIEF DESCRIPTION OF THE DRAWINGS

The invention will be better understood on reading the accompanying figures, which are given solely by way of example and not limiting in any way, in which:

FIG. 1A illustrates a mold according to the invention in the closed position.

FIG. 1B illustrates a mold according to the invention in the open position.

FIG. 2 illustrates a section of the mold according to the invention in the open position.

FIG. 3 illustrates a section of the mold according to the invention in packing phase.

FIG. 4 illustrates a section of the mold according to the invention in packing phase with the pins in the lowered position.

FIG. 5 illustrates a section of the mold according to the invention in the open position after packing.

### MORE DETAILED DESCRIPTION

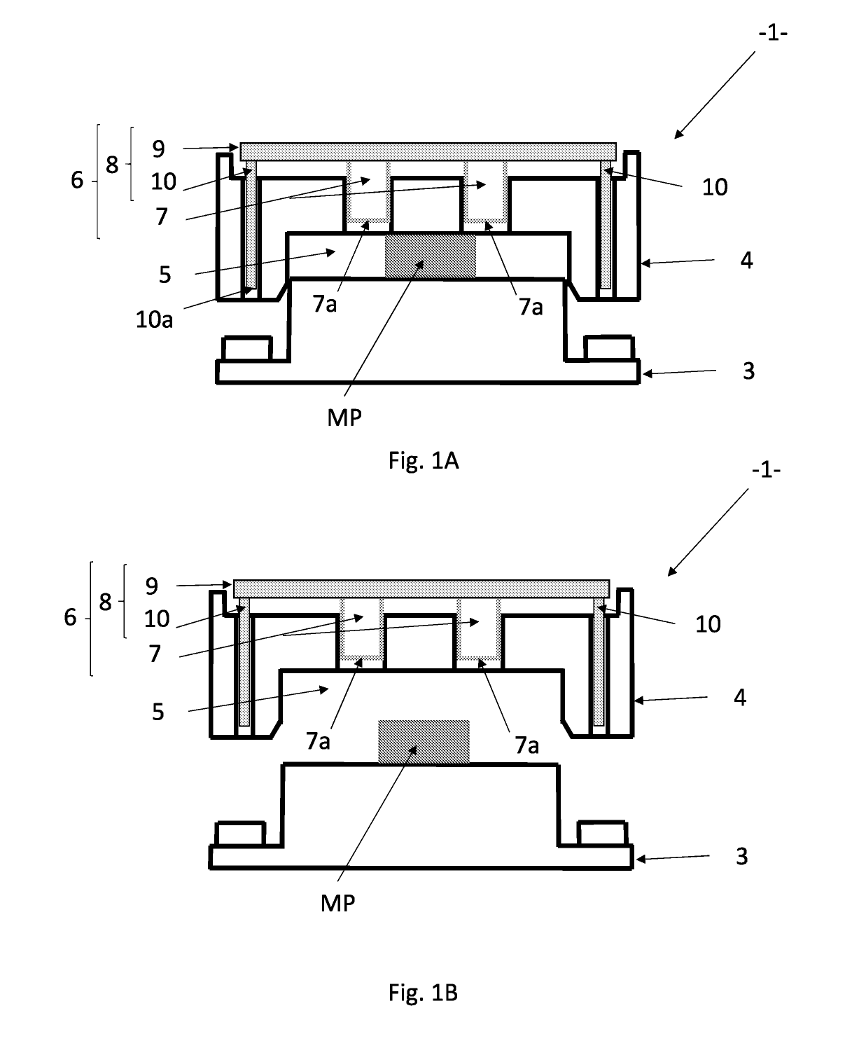

We now refer to FIGS. 1A and 1B which illustrate a mold (1) according to the invention for manufacturing a part (2) made from plastic material (MP). The mold (1) comprises a first element (3), fixed according to the example of FIGS. 1A and 1B, and, opposite, a second element (4) movable according to this example. The two elements form, in the closed position of the mold (1), a cavity (5) corresponding to the part (2) to be produced.

The closed position is defined as being the first position, during the descent of the movable element (4), in which the movable element (4) is in contact with the plastic material (MP) introduced into the mold for molding the part (2). When the mold starts to close, therefore, there is a space and thus a free volume of material between the two elements (3, 4) of the mold (1), necessary for the packing phase.

The second element (4) comprises at least one system (6) for producing molding openings in the part (2). This system (6) comprises:
at least one member (7) forming a cavity of an opening, in other words a local and molding shape for each opening, this member (7) being movable relative to the second element (4) in the closing direction the mold (1) between a retracted position (in the second element (4)) and an extended position (in the cavity (5)); and
at least one positioning means (8) for positioning the member (7) in the extended position relative to the first element (3).

An opening means an area with no material over at least substantially its entire thickness. According to the invention, when the part leaves the mold, the opening comprises a layer blocking it.

However, on the finished part, the opening is said to be a through opening since the layer has been removed. Thus, a through opening is an area with no material over its entire thickness.

The member (7) is movable in translation relative to the second element (4): it is adapted to slide in the second element (4), for example in the closing direction of the mold (1) as shown on the figures.

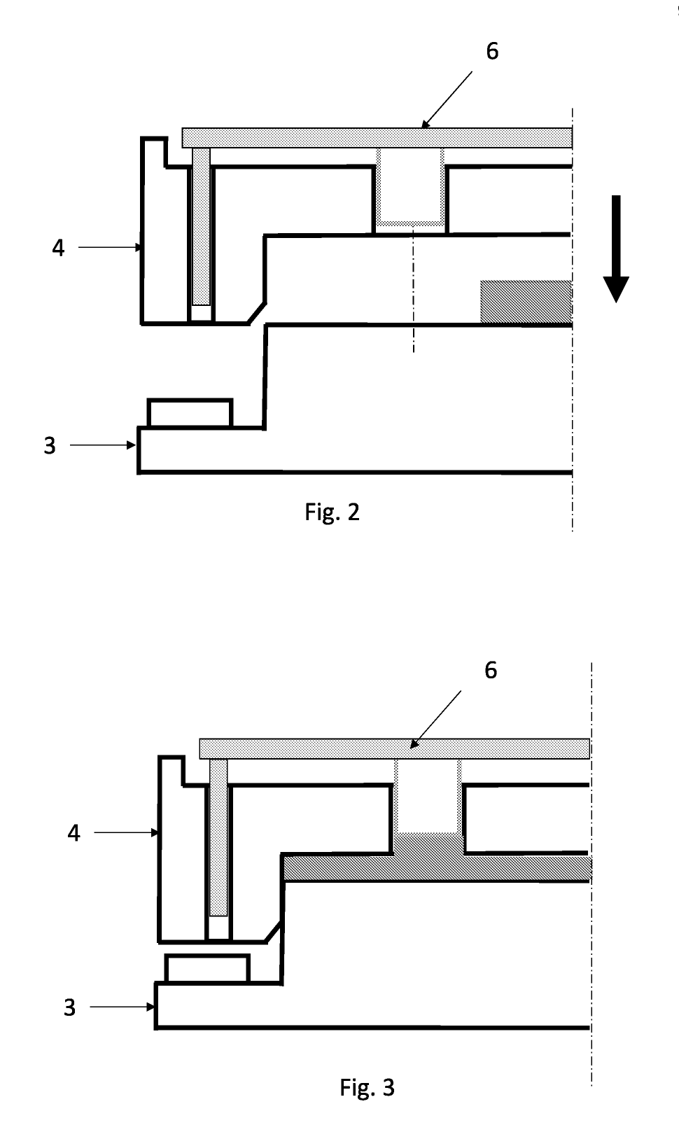

The member (7) comprises a surface (7a) forming a surface bearing on the plastic material (MP) in the cavity (5) of the mold. The position of the member (7) when the bearing surface (7a) is farthest from the fixed element (3) is called the “retracted position”. In this retracted position, the surface (7a) is preferably recessed (FIGS. 2, 3 and 5) relative to the surface of the element (4) forming the cavity (5). The bearing surface (7a) may also be positioned at the same level (FIGS. 1A and 1B) as the surface of the cavity, so that it does not modify the volume of the cavity of the mold (1). Conversely, the position of the member (7) when the bearing surface (7a) is closest to the fixed element (3), is called the “extended position”. In this extended position, the surface (7a) is inside the cavity (5).

According to the particular embodiment illustrated on the figures, the member (7) may be a pin, i.e. a rod, for example metallic, of height D1. The height D1 is at least close to the thickness of the part (2).

The pin (7) comprises a surface, called the upper surface with reference to FIG. 1B, and a second surface (7a), called the lower surface with reference to FIG. 1B. The lower surface (7a) forms the surface bearing on the plastic material (MP) in the mold cavity. The shape of this surface (7a) corresponds to that of the opening to be produced in the part (2).

The positioning means (8) positions the bearing surface (7a) of the member (7) relative to the surface of the fixed element (3) opposite, at a fixed distance, constant from one opening to another and repeatable from one part to another (in the meaning of the production variation) when the member (7) is in the extended position.

The positioning means (8) comprises, for example as shown on FIG. 1A: at least one movable plate (9) forming a plate for driving the member (7) provided with at least one mechanical stop (10). The movable plate (9) is connected to the movable member (7) so as to be able to move the movable member (7) in the thickness of the second element (4) between its retracted position and its extended position.

According to the embodiment of the figures, the movable plate (9) is substantially perpendicular to the closing direction of the mold (1). The plate (9) is movable in translation relative to the second element (4). The plate is adapted to move in the closing direction of the mold (1).

The plate (9) carries the movable pin (7) under its side located opposite the cavity (5). The plate (9) carries at least one mechanical stop (10) on its periphery, not opposite the cavity. This stop (10), parallel to the axis of closure of the mold (1) has a length D2. In the closed position of the mold (1), the stop (10) is initially not in contact with the other element (3) of the mold. However, in the packing phase of the mold (1), the movable plate (9) descends until the bearing surface (10a) of the stop (10) rests on the first element (3). Thus, the stop (10) positions the plate (9) at a fixed distance from the element (3), and therefore, positions the pin (7) in the extended position at a fixed distance from the element (3) irrespective of the relative position between the elements (3) and (4).

The distance between the bearing surface (7a) of the member (7) and the surface of the fixed element (3) in the cavity, surface opposite the member (7), is defined only with respect to fixed dimensions, and not with respect to the thickness of the plastic material in the cavity, and therefore not with respect to the position of the movable element (4).

This distance only depends on:
the distance (D1) between the bearing surface (7a) and the movable plate (9);
the distance (D2) between the bearing surface (10a) of the mechanical stop and the movable plate (9);
the distance (D3) between the dimension of the point of the element in contact with the stop (10) and the dimension of the surface of the element (3) opposite the pin (7). Note that this distance may be zero.

Thus, the system (6) is sized such that in the packing phase of the mold (1) and in the extended position of the movable member (7), the distance between the surface of the member (7) bearing on the plastic material and the first element (3) allows the formation of a thin layer of plastic material. Thus, the stop (10) and the pin (7) are sized, in particular the distance D2 and the distance D1, so that in the packing phase of the mold (1) and in the extended position of the pin (7), the distance between the bearing surface of the pin (7) and the first element (3) is not zero and less than 0.2 mm, preferably substantially equal to 0.1 mm.

Thus, the pin (7) forms on the part (2) an opening having a thin layer of approximately 0.1 mm to 0.2 mm.

Referring to FIG. 3, the distance between the bearing surface (7a) of the pin (7) in the extended position and the element (3) is denoted DF.

DF=D2−D1−D3

We want: DF =0.1 mm

According to the example described, the plate (9) is connected to the upper surface of the pin (7). It is clear that the plate (9) can be connected to a different part of the pin (7), and those skilled in the art will know how to adapt the dimensions of the pin (7) and of the stop (10) to respect the minimum value imposed (DF) between the bearing surface (7a) and the element (3).

It is obvious that the mold (1) has the same number of pins (7) as the number of openings to be produced in the part (2). These pins (7) can each be carried by a different plate (9) or, preferably, carried by the same plate (9) or a set of plates (9), each plate (9) carrying several movable pins (7).

According to a preferred embodiment, the system (6) comprises a plate (9) carrying a set of pins (7) and at least one stop (10).

According to one embodiment, the surface (7a) of the member (7) is recessed relative to the surface of the element (4) forming the cavity (5) when the member is in the retracted position. Thus, at the start of the packing phase, the plastic material (MP) flowing enters a volume formed between the bearing surface (7a) and the cavity (5). When the member (7) moves to the extended position, this material is forced into the cavity (5). If the cavity is already full, then the movable element (4) rises, releasing the volume required for this plastic material in the cavity (5).

Similarly, in the retracted position of the member (7), the rod (10) is preferably recessed in the moving element (4).

The invention also relates to a method for manufacturing a part (2) made of plastic material (MP) comprising at least one opening, using a mold (1) according to the invention. FIGS. 2 to 5 illustrate the operation of the mold (1) and the method according to the invention.

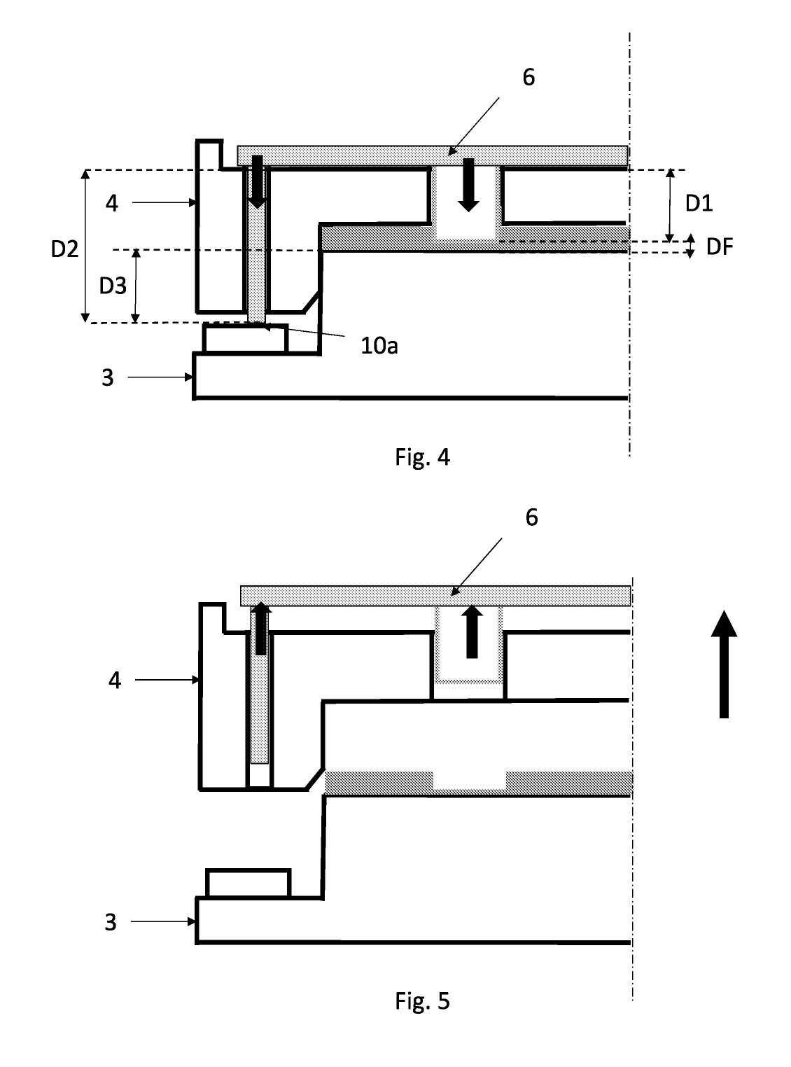

The method according to the invention comprises at least the following steps:
positioning (FIG. 2) the plastic material (MP) in the cavity (5) of the mold (1);
closing the mold (1) and packing (FIG. 3) the plastic material (MP) in the cavity, up to the nominal dimension of the part (2) to be molded;
after flow of the plastic material (MP) and before polymerization of the plastic material (MP), lowering (FIG. 4) the positioning means (8) until the stop (10) comes into contact with the mold element (3); the movable pin (7) is then in its extended position at a fixed and constant distance from the element (3) allowing the formation of a thin and repeatable (from one part to another) layer at the bottom of the opening;
opening the mold and ejecting the part (2); and
removing the layer formed in the opening created by the pin (7), for example by a method of shot-peening, projection of CO2 crystals, washing with water jet or compressed air or a brush.

Thus, the system (6) descends during the mold closing step, in other words at the same time as the step of lowering the movable element (4). The system (6) can be temporarily secured to the movable element (4) (to follow its movement), or be controlled so as to accompany the movable element (4) during its descent towards the fixed element (3).

The movable element (4) comes into contact with the material, leaving a space (gap) between the two elements (3, 4) of the mold (1). The plastic material (MP) is then compressed and starts to flow into the cavity (5). Due to the industrial production uncertainty regarding the quantity of plastic material actually introduced into the cavity (5), there is a dispersion in the thickness of material in the mold, and therefore, the space between the two elements (3, 4) of the mold (1) has a variable dimension.

Before the plastic material (MP) starts to polymerize, in other words to harden, the positioning means (8) descends independently of the movable member (4), taking with it the member (7), until it abuts against the fixed element (3). The movement of the positioning means (8) and therefore of the member (7) is therefore independent, disconnected from the movement of the movable element (4). Note that the movable member (4) can continue to move relative to the element (3). There may in fact be a variation in the position of this moving element (4) due to the flow of the material which fills the cavity. The element (4) continues to descend until the cavity is completely full, or the movable element (4) rises under the effect of the plastic material pushed into the cavity by the volume taken by the pin (7) entering the thickness of the material.

1. A mold for manufacturing a part made from plastic material, the mold comprising:
a first element and a second element forming, in a closed position of the mold, a cavity corresponding to the part,
wherein the second element includes at least one system for making molding openings in said part, said system including at least one member forming a cavity of an opening for the part, said at least one member being movable relative to the second element between a retracted position and an extended position extending into the cavity,
wherein said system includes at least one positioning means for positioning the member in the extended position relative to the first element, said system being sized such that, in the extended position of the member, a distance between a surface of the member bearing on the plastic material and the first element enables formation of a thin layer of plastic material having a repeatable thickness.

2. The mold according to claim 1, wherein the at least one positioning means is configured to position the bearing surface of the member relative to the surface of the first element opposite the member, at a fixed distance when the member is in the extended position.

3. The mold according to claim 1, wherein the at least one positioning means comprises at least one movable plate having at least one mechanical stop, the movable plate being movable relative to the second element.

4. The mold according to claim 3, wherein the mechanical stop rests against the first element in a packing phase of the mold.

5. The mold according to claim 3, wherein in the extended position of the movable member, a distance between the surface of the member bearing on the plastic material and the first element is not zero and less than 0.2 mm.

6. A method for manufacturing a part made from plastic material having at least one opening, using the mold according to claim 1, the method comprising:
positioning the plastic material in the cavity of the mold;
closing the mold;
packing the plastic material in the cavity up to a nominal dimension of the part;
after flow of the plastic material and before polymerization of the plastic material, lowering the at least one positioning means until a mechanical stop comes into contact with the mold;
opening the mold and ejecting the part; and
removing the layer formed in the opening.

7. The method according to claim 6, wherein the layer is removed via one of shot-peening, projection of CO₂ crystals, washing with water jet or compressed air or a brush.

8. A mold for manufacturing a part made from plastic material, the mold comprising:
a first element and a second element forming, in a closed position of the mold, a cavity corresponding to the part,
wherein the second element includes at least one system for making molding openings in said part, said system including at least one member forming a cavity of an opening for the part, said at least one member being movable relative to the second element between a retracted position and an extended position extending into the cavity,
wherein said system includes at least one moveable plate and at least one mechanical stop configured to position the member in the extended position relative to the first element, said system being sized such that, in the extended position of the member, a distance between a surface of the member bearing on the plastic material and the first element enables formation of a thin layer of plastic material having a repeatable thickness.
